(19) United States
(12) Patent Application Publication
(10) Pub. No.: US 2025/0347309 A1
(43) Pub. Date: Nov. 13, 2025

(54) Multi-Sided Screw and a Method of Using such a Multi-Sided Screw

(71) Applicant: Illinois Tool Works Inc., Glenview, IL (US)

(72) Inventor: Oscar Medina Garcia, Bad Mergentheim (DE)

(21) Appl. No.: 19/188,876

(22) Filed: Apr. 24, 2025

(30) Foreign Application Priority Data
May 13, 2024 (DE) 10 2024 113 33
Mar. 27, 2025 (DE) 10 2025 112 02

(51) Int. Cl. F16B 23/00; F16B 35/06; F16B 41/00

(52) U.S. Cl. CPC F16B 23/0038; F16B 35/06; F16B 41/002

(57) ABSTRACT

According to the disclosure, a screw is provided. It includes a head element having a base portion and a drive portion, and a threaded element connected thereto, wherein the drive portion includes at least two drive elements extending in the axial direction, which are springingly connected to the base portion in such a way that the drive portion, in an unstressed starting position, has in some regions a greater clearance than a tool, in particular a nut, a ratchet, or a socket, which corresponds to the drive portion, for actuating the drive, and such that, in a stressed mounting position in which the drive elements can spring inwardly in a radial direction via impingement by means of a tool, the drive portion has a clearance in some regions, which corresponds to approximately a clearance of a tool, such that the screw can be received and held in a tool in a loss-proof manner via a radially-outward acting force of the drive elements.

### RELATED APPLICATIONS

The present application claims the benefit of German Patent Application Nos. 10 2024 113 332.5, filed May 13, 2024, and DE 10 2025 112 026.9, filed Mar. 27, 2025, each titled “A Multi-Sided Screw and a Method of Using such a Multi-Sided Screw,” the contents of which are hereby incorporated by reference.

### BACKGROUND

The present disclosure relates to a screw, and more specifically to a multi-sided screw, as well as a corresponding method for its use. One objective of the disclosure is to provide an alternative to existing screws and methods known in the prior art. Another objective is to offer a multi-sided screw that is simple and cost-effective to manufacture. Additionally, the disclosure aims to provide a screw and method of use that ensure safe and reliable operation, particularly during installation.

### SUMMARY OF THE DISCLOSURE

The present disclosure relates generally to a multi-sided screw, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a representation of known socket bits for ferromagnetic screws having a magnet in a perspective view.

FIG. 1b illustrates a representation of known socket bits for ferromagnetic screws having a magnet in a cross-sectional view.

FIG. 1c illustrates a representation of known socket bits for ferromagnetic screws having a magnet in a long configuration with a spring magnet.

FIG. 2a illustrates a schematic representation of a multi-sided screw according to the disclosure in a top perspective view.

FIG. 2b illustrates a schematic representation of a multi-sided screw according to the disclosure in a bottom perspective view.

FIG. 3a illustrates the multi-sided screw according to the disclosure in the front view.

FIG. 3b illustrates the multi-sided screw according to the disclosure in the top plan view.

FIG. 3c illustrates the multi-sided screw according to the disclosure in the bottom view.

FIG. 4a illustrates a perspective cutaway view of the multi-sided screw according to the disclosure along cutting plane A-A.

FIG. 4b illustrates a perspective cutaway view of the multi-sided screw according to the disclosure along cutting plane B-B.

FIG. 5a illustrates a schematic functional representation of a laterally cut multi-sided screw according to the disclosure, having a nut of a tool mounted thereon, with attachment to the active face.

FIG. 5b illustrates a schematic functional representation of the laterally cut multi-sided screw of FIG. 5a with engagement with the deflection region.

FIG. 5c illustrates a schematic functional representation of the laterally cut multi-sided screw of FIG. 5a with end position on the drive region.

FIG. 5d illustrates a schematic functional representation of the laterally cut multi-sided screw of FIG. 5a with an enlarged representation of a sub-region of FIG. 5b.

FIG. 6a illustrates a perspective view of an alternative embodiment of the multi-sided screw according to the disclosure, wherein the drive elements are given a stiffening structure on the inside.

FIG. 6b illustrates a top plan view of the alternative embodiment of the multi-sided screw according to the disclosure, wherein the drive elements are given a stiffening structure on the inside.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. The terms “inside” and “outside” indicate directions in relation to a geometrical central axis/longitudinal axis or a center of a respectively described component, device, or apparatus, wherein the meaning is obvious from the description. Other terms such as “proximal” and “distal” indicate relative positions in relation to the mounting direction, i.e., the distal end points toward the mounting direction and the proximal end points away from the mounting direction.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The terms “connected,” “attached,” “coupled,” “mounted” moreover each describe direct connections between two elements or components, i.e., without an intermediate element, but also indirect connections between elements or components, i.e., with at least one intermediate element.

The terms “multi-sided screw” and “screw” are understood to mean the same in the following description and are accordingly interchangeable, i.e., the screw is understood as a multi-sided screw having any number of edges. Preferably, but not exclusively, the multi-sided screw is a hex screw.

According to the disclosure, a multi-sided screw is provided. It comprises: a head element with a base portion and a drive portion, and a threaded element connected thereto, wherein the drive portion comprises at least two drive elements extending in the axial direction, which are springingly connected to the base portion in such a way that the drive portion, in an unstressed starting position, has in some regions a greater clearance than a tool, for example a nut, a ratchet, or a socket, configured so as to correspond to the drive portion for actuating the drive portion, and in a stressed mounting position in which the drive elements can spring inwardly in the radial direction via impingement by means of a tool, the drive portion has, in some regions, a clearance that corresponds approximately to a clearance of a tool, such that the multi-sided screw can be received and held in a tool in a loss-proof manner via a radially-outward acting force of the drive elements.

The present disclosure is wherein a drive configured on the head element comprises at least two drive elements configured in a springing manner. These drive elements have a greater clearance in a starting position than a corresponding inner diameter of a nut of a tool.

Due to the springing design of the drive elements, they spring inwardly in a radial direction when a tool, in particular a nut, is mounted and act with a radially outward pressing force on an inner sheath wall of the nut. In this way, the screw according to the disclosure can be held in the tool in a loss-proof manner. This results in significant simplification during mounting, similar to that of magnetic screws in combination with magnetic tools. Furthermore, the type of drive of the multi-sided screw according to the disclosure provides an alternative to screws known in the prior art.

The base portion can be formed as a circular disk or in a flange-like manner, wherein the drive elements are springingly connected to the base portion, and wherein a slot extending in the axial direction is provided between two adjacent drive elements, such that the drive elements are arranged (e.g., spaced apart) from one another.

A radially outwardly extending groove can be formed in the base portion in the region between two adjacent drive elements in order to improve a spring effect of the drive elements.

The drive portion can comprise at least four or five or six or more drive elements, wherein an outer surface of a drive element, which is oriented substantially radially outward, forms an active face, and the active face comprises a region that flares conically in a mounting direction, such that the drive elements in this region form an insertion region for a tool, and wherein the conically flaring portion transitions over a tangentially circumferential linear deflection region into a conically tapering region, such that the drive elements form a drive region in this tapering region.

In the context of the present disclosure, the “mounting direction” is understood to mean a direction in which a screw can be inserted into a correspondingly configured internal thread. The mounting direction is thus a direction parallel to the axial direction of the multi-sided screw, which faces towards a corresponding internal thread formed in a component. Thus, the mounting direction also extends orthogonally to a surface of a corresponding component that is given an internal thread.

The structural design of the drive portion with the insertion region which flares conically and tapers in the mounting direction significantly improves a loss-proof holding of the multi-sided screw according to the disclosure in a nut of a tool.

In the mounting position, the drive region of the drive elements can extend approximately parallel to the axial direction when arranged in a tool in a state where the drive elements are pushed inwardly by a tool in a radial direction, thereby generating a radially outwardly acting pressing force in the tool. In this way, the force transfer surface between a tool, in particular a nut, and the drive region of the multi-sided screw according to the disclosure is significantly improved.

The drive elements can optionally have a stiffening structure on their radially inwardly facing sides. By providing such a stiffening structure, both the stiffness of the drive elements and their spring effect can be adapted to the needs of the multi-sided screw and the corresponding intended purpose.

The multi-sided screw can be made of a plastic, in particular by means of a single-component injection molding process. Thus, according to the present disclosure, a multi-sided screw made of plastic can be provided, which can be held in a loss-proof manner in a conventional standard tool.

Alternatively, the multi-sided screw can also be made of a metal, in particular a non-magnetizable metal, such as stainless steel or aluminum in order to arrange it in a loss-proof manner in a tool. Furthermore, such a multi-sided screw formed from plastic can be produced in an extremely cost-efficient manner according to the disclosure.

The multi-sided screw can comprise a cylindrical element between the head element and the threaded element. Such cylindrical elements can be utilized, for example, according to the type of spring in order to impart a corresponding biasing force on the screw.

The same applies to the circular disk-shaped base portion, which can be used similar to a washer for force distribution and transfer. Furthermore, according to the present disclosure, a method for using a multi-sided screw shown above is provided, in particular for the loss-proof holding of a multi-sided screw. It comprises the following steps: inserting a head region of the multi-sided screw in the axial direction in a nut of a tool, wherein springingly configured drive elements of the screw are pushed inwardly by means of the nut in a radial direction, such that the drive elements act with a radially outwardly directed counterforce on the nut in such a manner that the screw is held in the tool in a loss-proof manner.

The advantages of the method according to the disclosure analogously correspond to the advantages described above on the basis of the multi-sided screw according to the disclosure. Furthermore, according to the present disclosure, a method for using a multi-sided screw according to the present disclosure is provided, in particular for actuating a multi-sided screw. It comprises the following steps: abutting a drive region of springingly configured drive elements of a screw head against a nut of a tool in order to transfer a torque from the tool to the multi-sided screw via the nut.

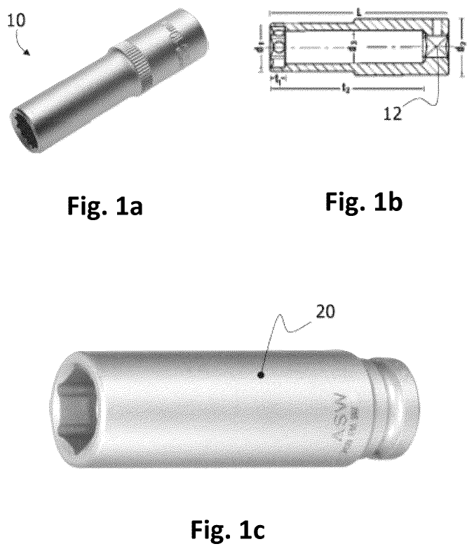

FIGS. 1a through 1c shows typical examples of known socket bits (10, 20) that are securely “fixed”, e.g., via a magnet (12) or spring magnets arranged in the nut, during use. Specifically, FIG. 1a illustrates a representation of known socket bits for ferromagnetic screws having a magnet in a perspective view, while FIG. 1b illustrates a representation of known socket bits for ferromagnetic screws having a magnet in a cross-sectional view and FIG. 1c illustrates a representation of known socket bits for ferromagnetic screws having a magnet in a long configuration with a spring magnet. However, the “capturing” of the screw is only possible if the screw or at least the screw head consists of a ferromagnetic metal. Screws made of other, non-magnetic materials could consequently fall out of the insert again. However, for many applications, straight screws made of such “cheaper” and/or “lighter” materials are advantageous, either to save costs or to reduce total weight.

A multi-sided screw 100 according to the disclosure is described in the following on the basis of an exemplary embodiment.

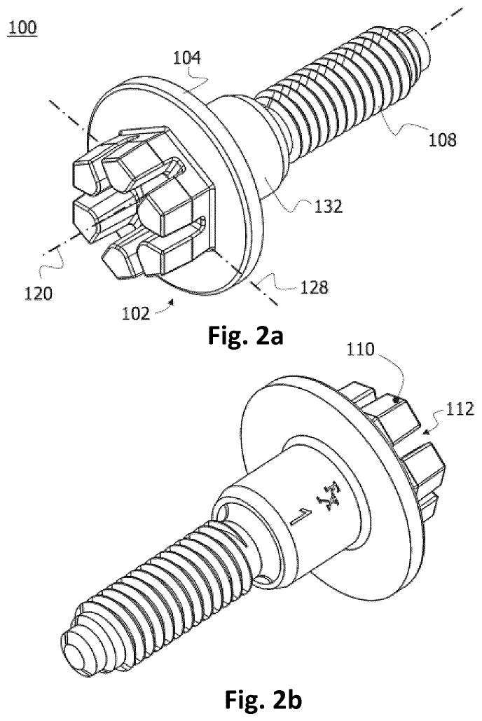

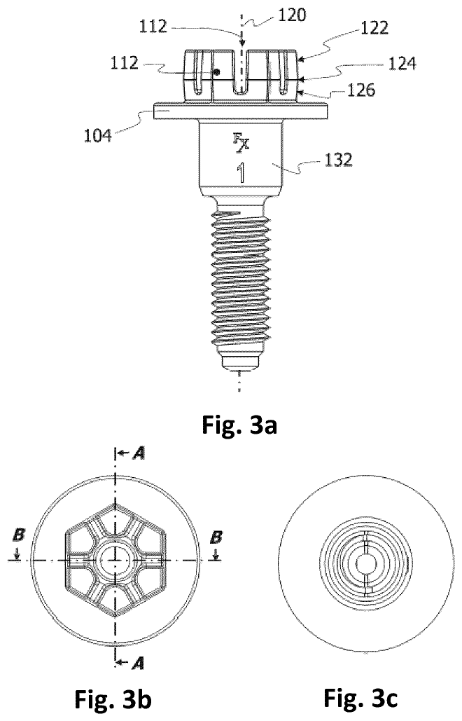

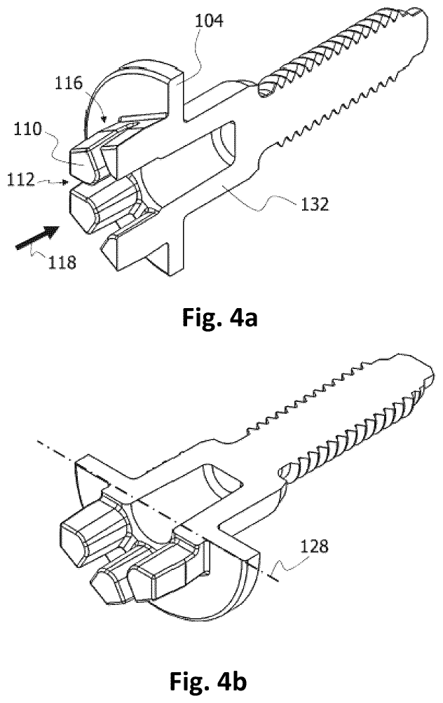

FIG. 2a illustrates a schematic representation of a multi-sided screw according to the disclosure in a top perspective view, while FIG. 2b illustrates a schematic representation of a multi-sided screw according to the disclosure in a bottom perspective view. FIG. 3a illustrates the multi-sided screw according to the disclosure in the front view, while FIG. 3b illustrates the multi-sided screw according to the disclosure in the top plan view and FIG. 3c illustrates the multi-sided screw according to the disclosure in the bottom view. FIG. 4a illustrates a perspective cutaway view of the multi-sided screw according to the disclosure along cutting plane A-A, while FIG. 4b illustrates a perspective cutaway view of the multi-sided screw according to the disclosure along cutting plane B-B.

The multi-sided screw or screw 100 (here, specifically a hex screw) comprises, in an axial direction (central axis) 120 or in a mounting direction 118 in which the screw 100 is insertable into an internal threading of a corresponding component (not shown), a head element 102, a cylindrical element 132 connected thereto, and a threaded element 108 connected to the cylindrical element 132.

The cylindrical element 132 is optional and can be provided, for example, in order to simplify manufacture or to save production costs or also to achieve a predetermined spring effect via the cylindrical element 132.

The head element 102 has a circular disk-shaped base portion 104, on which six drive elements 110 extending in the axial direction 120 are molded in an intended manner in the radial direction 128, as well as being approximately circumferentially and approximately equally spaced apart from one another.

The drive elements 110 are springingly connected to the base portion 104, i.e., the drive elements are arranged so as to be radially springingly deflectable.

In an unstressed starting position (see FIGS. 2a through 2b and 3a through 3c), the drive elements 110 forming a corresponding drive portion 106 for receiving a tool 30 have a greater clearance (i.e., bit size) than a tool 30, in particular a nut 32, configured so as to correspond to the drive portion 106.

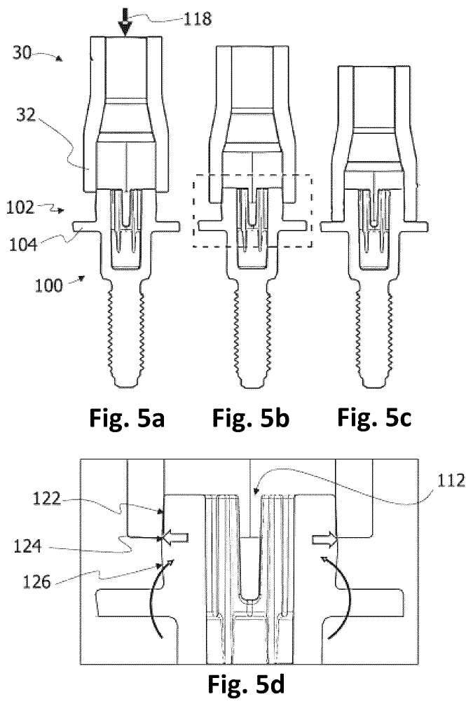

FIG. 5a illustrates a schematic functional representation of a laterally cut multi-sided screw according to the disclosure, having a nut of a tool mounted thereon, with attachment to the active face, while FIG. 5b illustrates engagement with the deflection region, FIG. 5c illustrates it with end position on the drive region, and FIG. 5d illustrates an enlarged representation of a sub-region of FIG. 5b.

In a stressed mounting position (see FIGS. 5a through 5d), in which the drive elements 110 can spring inwardly in the radial direction (128) via impingement by means of a tool 30, in particular a nut 32, the drive portion 106 has, in some regions, a clearance that corresponds approximately to a clearance of the tool 30 or nut 32, such that the screw 100 can be received and held in the tool 30 or nut 32 of the tool 30 in a loss-proof manner via a radially-outward (128) acting force of the drive elements 110.

A slot 112 extending in the axial direction 120 is provided between two adjacent drive elements 110, such that the drive elements 110 are spaced apart from one another. In the example described herein, the drive elements 110 are arranged circumferentially equally spaced apart from one another. However, this does not exclude the possibility that the drive elements 110 are also circumferentially arranged at different distances.

According to the present disclosure, six drive elements 110 extending in the axial direction 120 are molded onto the drive portion 106. However, four or five or seven or eight or ten or twelve or more drive elements 110 can also be provided.

An outer surface of a drive element 110 extending approximately in the axial direction 120 and oriented substantially radially outward forms an active face 116 according to the disclosure. The active face 116 in the mounting direction 118 initially has a conically flaring region, so that the drive elements 110 in this region form an insertion region 122 for a tool 30 (see FIG. 5a).

This conically flaring region is connected via a tangentially circumferential linear deflection region 124 to a region that conically tapers in the mounting direction 118, so that the drive elements 110 in this conically tapering region form a drive region 126.

In the mounting position 118 when arranged in a tool 30 in a state (see FIG. 5c) where the drive elements 110 are pushed inwardly by a tool 30 in a radial direction 128, the drive region 126 of the drive elements 110 creates a radially (128) outwardly acting pressing force in the tool 30 (or nut 32). In the exemplary embodiment of the multi-sided screw 100 according to the disclosure described herein, the respective edges of the multi-sided screw head are molded on the corresponding drive element 110 centrally and radially directed outward (or towards the middle), wherein the respective drive element 110 tapers radially inwardly and in a rounded manner.

As shown in FIG. 4a and FIG. 4b, the cylindrical element 132 can be configured so as to be hollow. Preferably, the screw 100 is made of a plastic, in particular by means of a single-component injection molding process. Alternatively, the screw 100 can also be made of a metal, in particular a non-magnetizable metal, such as stainless steel or aluminum.

FIGS. 5a through 5d further show a method according to the disclosure for the loss-proof holding of a screw 100. The method comprises the following steps, among others: attachment of a nut 32 to the insertion region 122 of the head element 102 of the screw 100; pushing the nut 32 in the axial direction 120 over the insertion region 122 towards the deflection region 124, wherein the springingly configured drive elements 110 of the screw 100 are pushed inwardly by way of the nut 32 in the radial direction 128; pushing the nut 32 further in the axial direction 120 over the deflection region 124 onto the drive region 126, in such a way that the drive elements 110 act with an outwardly directed counterforce in the radial direction 128 on the nut 32 such that the screw 100 is held by the tool 30 in a loss-proof manner.

FIG. 5d shows an enlarged region of the screw 100 and the attached nut 32 that lies on the deflection region 124. At this point, the drive elements 110 are further pressed radially inward by further advancement of the nut 32 and are aligned such that the outwardly facing surfaces of the drive region 126 are arranged substantially parallel to the inner surfaces of the nut 32. This ensures a uniform transmission of force between the tool 30 and the screw 100.

Furthermore, according to the present disclosure, a method for actuating the screw 100 is provided. The method comprises the following steps: abutting the drive region 126 of springingly configured drive elements 110 of a head element 102 of the screw 100 against a nut 32 of a tool 30 in order to then transfer a torque from the tool 30 to the screw 100 via the nut 32.

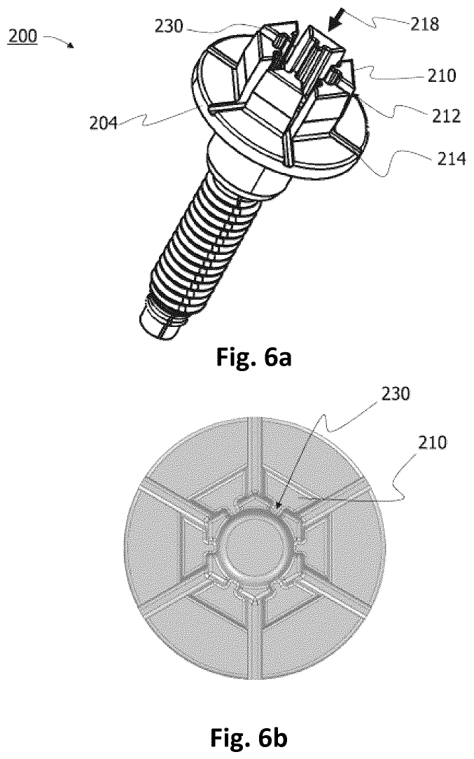

FIGS. 6a and 6b show an alternative embodiment 200 of the multi-sided screw according to the disclosure. Specifically, FIGS. 6a and 6b illustrate, respectively, perspective and top plan views of an alternative embodiment of the multi-sided screw according to the disclosure, wherein the drive elements are given a stiffening structure on the inside.

As illustrated, the slots 212 separating the drive elements 210 are arranged on the respective edges of the multi-sided screw head. In the alternative embodiment of the multi-sided screw 200, radially outwardly extending grooves 214 are formed in the base portion 204 in a face of the base portion 204 that faces counter to the mounting direction 218 in a manner so as to be radially aligned with the slots 212. According to the alternative embodiment of the multi-sided screw, the drive elements 210 further comprise a stiffening structure 230 formed in a T-shape, when viewed in the top plan view, on its side facing in the radial direction.

Alternatively, differently formed stiffening elements or structures can also be provided in order to make the drive elements 110, 210 more stable or to save weight, accordingly.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

10 Bit with magnet
20 Long bit with spring magnet
30 Tool
32 Nut
100, 200 Multi-sided screw
102 Head element
104, 204 Base portion
106 Drive portion
108 Threaded element
110, 210 Drive elements
112, 212 Slot
116 Active face
118, 218 Mounting direction
120 Axial direction
122 Insertion region
124 Deflection region
126 Drive region
128 Radial direction
132 Cylindrical element
214 Groove
230 Stiffening structure

What is claimed is:

1. A multi-sided screw (100) comprising:
a head element (102) with a base portion (104) and a drive portion (106), and
a threaded element (108) connected thereto, wherein the drive portion comprises at least two drive elements (110) extending in an axial direction (120), which are springingly connected to the base portion in such a way that the drive portion, in an unstressed starting position, has in some regions a greater clearance than a tool configured so as to correspond to the drive portion for actuating the drive portion, and
in a stressed mounting position in which the drive elements can spring inwardly in a radial direction (128) via impingement by means of a tool, the drive portion has, in some regions, a clearance that corresponds approximately to a clearance of a tool, such that the multi-sided screw can be received and held in a tool in a loss-proof manner via a radially-outward acting force of the drive elements.

2. A multi-sided screw according to claim 1, wherein
the base portion is formed as a circular disk or in a flange-like manner, wherein the drive elements are springingly connected to the base portion, and wherein a slot (112) extending in the axial direction is provided between two adjacent drive elements, such that the drive elements are arranged spaced apart from one another.

3. A multi-sided screw according to claim 2, wherein
a radially outwardly extending groove (114) is formed in the base portion in a region between two adjacent drive elements in order to improve a spring effect of the drive elements.

4. A multi-sided screw according to claim 1, wherein
the drive portion comprises at least four or five or six or more drive elements, wherein an outer surface of a drive element, which is oriented substantially radially outward, forms an active face (116), and the active face comprises region that flares conically in a mounting direction (118), such that the drive elements in this region form an insertion region (122) for a tool, and wherein the conically flaring portion transitions over a tangentially circumferential linear deflection region (124) into a conically tapering region, such that the drive elements form a drive region (126) in this tapering region.

5. A multi-sided screw according to claim 4, wherein in the mounting position, the drive region of the drive elements extends approximately parallel to the axial direction (120) when arranged in a tool in a state where the drive elements are pushed inwardly by a tool in a radial direction, thereby generating a radially outwardly acting pressing force in the tool.

6. A multi-sided screw according to claim 1, wherein the drive elements have a stiffening structure on their radially inwardly facing side.

7. A multi-sided screw according to claim 1, wherein
the multi-sided screw is made of a plastic via a single-component injection molding process, or
the multi-sided screw is made of a non-magnetizable metal.

8. A multi-sided screw according to claim 1, wherein the multi-sided screw comprises a cylindrical element between the head element and the threaded element.

9. A method for holding a multi-sided screw (100) in a loss-proof manner, the method comprising the following steps:
inserting a head region (102) of the multi-sided screw of claim 1 in the axial direction (120) in a nut (32) of a tool (30),
wherein springingly configured drive elements (110) of the multi-sided screw are pushed inwardly by means of the nut in a radial direction (128), such that the drive elements act with a radially outwardly directed counterforce on the nut in such a manner that the multi-sided screw is held in the tool in a loss-proof manner.

10. The method according to claim 9, further comprising the step of:
abutting a drive region (126) of springingly configured drive elements (110) of a head element (102) of the multi-sided screw against a nut (32) of a tool (30) in order to transfer a torque from the tool via the nut to the multi-sided screw.
